(19) United States
(12) Patent Application Publication
(10) Pub. No.: US 2011/0105717 A1
(43) Pub. Date: May 5, 2011

(54) METHOD FOR SYNTHESIZING THIOPHENES

(75) Inventors: Frank Rauscher, Koln (DE); Björn Henninger, Koln (DE); Leslaw Mleczko, Dormagen (DE); Kilian Tellmann, Koln (DE)

(73) Assignee: BAYER TECHNOLOGY SERVICES GMBH, Leverkusen (DE)

(21) Appl. No.: 12/517,235

(22) PCT Filed: Aug. 12, 2007
(86) PCT No.: PCT/EP2007/010710

§ 371 Date: Dec. 29, 2010

(30) Foreign Application Priority Data
Dec. 21, 2006 (DE) 10 2006 061 966.8

(51) Int. Cl. C08G 61/12; C08G 75/00

(52) U.S. Cl. 528/378; 528/380

(57) ABSTRACT

Process for preparing thiophenes useful for the preparation of semiconductive polymers or semiconductive oligomers with a defined mean molar mass and a narrow molecular mass distribution.

The invention relates to a process for preparing thiophenes. The aim of the process is to prepare semiconductive polymers or semiconductive oligomers with a defined mean molecular weight and a narrow molecular mass distribution.

The field of molecular electronics has developed rapidly in the last 15 years with the discovery of organic conductive and semiconductive compounds. In this time, a multitude of compounds which have semiconductive or electrooptical properties have been found. It is generally understood that molecular electronics will not displace conventional semiconductor units based on silicon. Instead, it is assumed that molecular electronic components will open up new fields of application in which suitability for coating large surfaces, structural flexibility, processability at low temperatures and low costs are required. Semiconductive organic compounds are currently being developed for fields of use such as organic field-effect transistors (OFETs), organic luminescent diodes (OLEDs), sensors and photovoltaic elements. As a result of simple structuring and integration of OFETs into integrated organic semiconductor circuits, inexpensive solutions for smart cards or price tags, which have not been realizable to date with the aid of silicon technology owing to the cost and the lack of flexibility of the silicon units, are becoming possible. It would likewise be possible to use OFETs as switching elements in large-area flexible matrix displays.

All compounds have continuous conjugated units and are, according to molecular weight and structure, divided into conjugated polymers and conjugated oligomers. Oligomers are generally distinguished from polymers in that oligomers usually have a narrow molecular weight distribution and a molecular weight up to about 10 000 g/mol (Da), whereas polymer generally have a correspondingly higher molecular weight and a broader molecular weight distribution. However, it is more sensible to distinguish on the basis of the number of repeat units, since one molar unit can quite possibly achieve a molecular weight of 300 to 500 g/mol, as, for example, in the case of (3,3″″-dihexyl) quarterthiophene. In the case of distinction according to the number of repeat units, molecules are still referred to as oligomers in the range of 2 to about 20 repeat units. However, a fluid transition exists between oligomers and polymers. Often, the distinction between oligomers and polymers is used to express the difference in the processing of these compounds. Oligomers are frequently evaporable and can be applied to substrates by means of vapour deposition processes. Polymers frequently refer to compounds which—irrespective of their molecular structure—are not evaporable and are therefore generally applied by means of other processes.

An important prerequisite for the production of high-value organic semiconductor circuits is compounds of extremely high purity. In semiconductors, order phenomena play an important role. Hindrance of uniform alignment of the compounds and development of particle interfaces leads to a dramatic decline in the semiconductor properties, such that organic semiconductor circuits which can be built using compounds not of extremely high purity are generally unusable. Remaining impurities can, for example, inject charges into the semiconductive compound (“doping”) and hence reduce the on/off ratio or serve as charge traps and hence drastically lower the mobility. Moreover, impurities can initiate the reaction of the semiconductive compounds with oxygen and oxidizing impurities can oxidize the semiconductive compounds and hence shorten possible storage, processing and operating times.

The most important semiconductive polymers and oligomers include the poly/oligothiophenes whose monomer unit is, for example, 3-hexylthiophene. In the case of linkage of individual or a plurality of thiophene units to give a polymer or oligomer, it is necessary in principle to distinguish between two processes—the simple coupling reaction and the multiple coupling reaction in the sense of a polymerization mechanism.

In the case of the simple coupling reaction, generally two thiophene derivatives with identical or different structure are coupled to one another in one step so as to form a molecule which then consists of one unit of the two monomers in each case. After a removal, purification and refunctionalization, this new molecule can in turn serve as the monomer and thus open up access to longer-chain molecules. This process leads generally to exactly one oligomer, the target molecule, and hence to a produce without molar mass distribution, and few by-products. They also offer the possibility to build up very defined block copolymers by the use of different monomers. A disadvantage here is that molecules which consist of more than two monomer units, even owing to the purification steps, can be prepared only with very great difficulty, and the economic investment can be justified only in the case of processes with very high quality demands on the product.

For instance, EP402269 describes the preparation of oligothiophenes by oxidative coupling, for example using iron chloride (page 7, lines 20-30, page 9, lines 45-55). However, the synthesis method leads to oligothiophenes which are present in the cationic form and hence in a conductive form and no longer in the neutral semiconductive form (EP402269, page 8, lines 28-29). These oligothiophenes are thus unusable for application in semiconductive electronics, since the oligothiophenes do conduct electrical current efficiently in the cationic form but do not have a semiconductor effect. It is possible to reduce cationic oligothiophenes, for example, by electrochemical or chemical reaction, but this is complicated and does not always lead to the desired result.

One alternative is the coupling of organolithium compounds with iron(III) salts, for example iron(III) chloride. This reaction affords generally undoped, i.e. neutral, oligothiophenes, but side reactions in this reaction also lead to products highly contaminated with iron and chlorine. Instead of iron(III) chloride, other iron(III) compounds, for example iron(III) acetylacetonate, have been proposed as coupling reagents (J. Am. Chem. Soc., 1993, 115, 12214). Owing to the relatively low reactivity of this coupling reagent, this variant, however, has the disadvantage that the reaction has to be performed at elevated temperature. The relatively high temperature frequently promotes side reactions, so that qualitatively high-value oligothiophenes are not obtainable even by intensive purifying operations (Chem. Mater., 1995, 7, 2235). A further method of preparing oligothiophenes described in the literature is the oxidative coupling by copper salts, especially by copper(II) chloride (Kagan, Heterocycles, 1983, 20, 1937). However, in the preparation of, for example, sexithiophene, it was found that the product, after purification by recrystallization, still contains chlorine and copper, of which at least the chlorine is present at least partly in chemically bound form to the oligothiophene and cannot be removed any further even by further complicated purification (Katz et al., Chem. Mater., 1995, 7, 2235). An improvement to this method is described in DE10248876 and is based on the presence of the oligolithium intermediate to be coupled in dissolved form before the addition of the catalyst.

Further processes are based on coupling reactions of Grignard compounds (JP 02 250 881) or organozinc compounds (U.S. Pat. No. 5,546,889) in the presence of nickel catalysts. In this case, for example proceeding from halogenated thiophenes, a portion is converted to the organometallic intermediate with the aid of magnesium or of an alkylmagnesium halide and then coupled to the unconverted portion by addition of a nickel catalyst. This coupling method has been described, inter alia, as the Kumada method (Kumada, Pure Appl. Chem., 1980, 52, 669-679) (Tamao, Sumitani, Mumada, J. Am. Chem. Soc., 1972, 94, 4374-4376). The coupling of two organometallic intermediates to one dihalogenated derivative, in which a trimer is formed, is considered to be a variation thereon.

However, what is common to all processes is that several synthesis steps are always necessary for the selective preparation of an oligomer proceeding from the corresponding thiophene base unit. At the same time, it is unimportant whether the monomer used, for example terthiophene for the synthesis of a hexathiophene, has to be prepared in several stages, or else the hexathiophene is obtained by a multistage coupling of a thiophene. There is thus the need to be able to prepare oligomers directly from a monomer, as is the case for the polymerization of thiophenes to prepare polythiophenes.

In the polymerization of thiophenes, several monomer units are coupled to one another within one reaction stage. This usually forms polymers having mean molar masses greater than 10 000 g/mol. Differences in the products are made predominantly on the basis of their molecular weight, their distribution and the properties, especially with regard to the conductivity. With regard to the multitude of processes, reference is made to the description in the relevant sources (R. D. McCullough, Advanced Materials, 1998, 10(2), 93-116) (D. Fichon, Handbook of Oligo- and Polythiophenes, 1999, Wiley-VCH).

While electrochemical polymerizations and iron salt-supported polymerizations lead to already doped and hence conductive polymers and are therefore not amiable to use in semiconductor electronics without complicated purification, the methods described below are suitable for preparing the semiconductive polymers. In principle, the most important synthetic routes for the preparation of semiconductive thiophene polymers can be divided into four methods: the McCullough, Rieke, Stille and Suzuki methods. In all methods, polymers can be prepared with high regioregularity, i.e., in the case of unsymmetrically substituted thiophene derivatives, a head-to-tail coupling proceeds predominantly, for example a 2-5′ coupling of 3-hexylthiophene. While the Stille and Suzuki methods are, however, employed more commonly in the stepwise synthesis of oligomers, especially from different units (H. C. Starck, DE 10 353 094, 2005) (BASF, WO93/14079, 1993), the McCullough (EP 1 028 136 B1, U.S. Pat. No. 6,611,172, U.S. Pat. No. 247,420, WO 2005/014691, US 2006/0155105) and Rieke (U.S. Pat. No. 5,756,653) methods are those which are employed for the commercial preparation of polythiophenes.

What is common to all is the regioselective chain growth reaction, in which, proceeding from an organometallic compound (Sn, Mg, Zn) or a borane compound as a monomer with the aid of a catalyst (Nickel (e.g. Ni(dppp)Cl₂), palladium (e.g. Pd(PPh₃)₄), a polymer is formed regioselectively. Differences are frequently made in the synthesis of the actual monomer, possible purification steps and purities of the monomers, the type of catalyst and the solvent used. In addition, the degree of regioselectivity serves as a distinguishing feature between the possible syntheses.

In the McCullough method, a regioselectively prepared Grignard compound is used as the monomer in the actual polymerization (X=halogen, R=substituent):

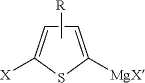

For the polymerization, in the Kumada method (cross-coupling metathesis reaction), the polymerization in a catalyst cycle is commenced with the aid of a nickel catalyst (preferably Ni(dppp)Cl₂). In this case, the reaction conditions specified are −5° C. to 25° C. in the first publications up to polymerization under reflux conditions in recent publications. Apart from different reaction temperatures in some cases, this step in the polymerization is the same in all corresponding processes. For all processes, the same possibilities in the catalyst selection (for example alternatively Ni(dppe)Cl₂) and in the solvent selection (for example THF, toluene, etc.) apply, provided that a homogeneous solution is obtained. What is likewise common to all processes is that exclusively batchwise processes are described.

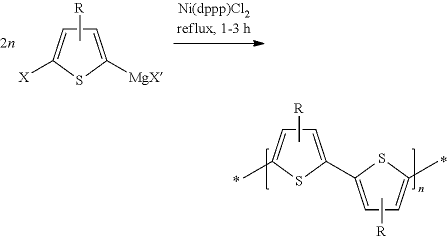

Crucial differences are described in the preparation of the abovementioned Grignard compound. According to commonly known syntheses, it is possible to use alkylmagnesium halides (McCullough) or elemental magnesium (Merck, Honeywell) in order to convert an initially charged dihalogen compound of the alkylthiophene (even with different halogens as X and X′) to the desired intermediate. Both methods have their advantages and disadvantages. In the case of synthesis with elemental magnesium, a removal of unconverted magnesium before the addition of the catalyst is recommended. At the same time, this is a heterogeneous mixture (“slurry”) and an activation of the magnesium additionally has to be effected by suitable measures (for example addition of Br₂). Advantages are especially the price of magnesium compared to alkymagnesium reagents and the avoidance of alkyl halides in the by-products. Advantages in the case of use of magnesium-Grignard compounds are the homogeneity of the reaction solution and the avoidance of purification steps between the individual stages (one-pot synthesis). A disadvantage is the formation of methyl bromide, which is formed from the methylmagnesium bromide used with preference in the Grignard stage. Methyl bromide is a substance which is gaseous above −4° C., is harmful to health, and can be removed from offgases with difficulty or only with a considerable level of technical complexity. In addition to the methods mentioned, it is also possible to obtain the corresponding Grignard compound of the alkylthiophene by reacting the dihalogen compound of the alkylthiophene with magnesium and a small amount of alkylhalide, for example ethyl bromide (Khimiya Geterotsiklicheskikh Soedinenii, (4), 468-70; 1981).

The polymers are generally obtained in the necessary purity via Soxhlet extractions.

Interestingly, the prior art initially describes the polymers prepared as “normal” polymers of the particular thiophene unit. The polymers should thus not bear any end group other than H. The perception was based initially on an early perception with regard to the catalyst cycle present and lack of means of structural elucidation by means of NMR spectroscopy. Only in more recent studies regarding the possible reaction mechanism (R. D. McCullough, Macromolecules, 2004, 37, 3526-3528 and Macromolecules, 2005, 38, 8649-8656) show that at least one end group of the polymer must be a halogen. For the second group, it is assumed that a complex of nickel (II) and the polymer is initially present, and the complexed group is hydrolysed by the workup with methanol/water. This is certainly correct in that the nickel catalyst must be present in an aquimolar ratio to the polymer. Otherwise, some polymer chains should bear a halide at both ends. In the course of these studies, the synthesis of end group-functionalized polymers was also combined with the actual polymerization, so that relatively easy access to these end-capped polymers is enabled (R. D. McCullough, Macromolecules, 2005, 38, 10346-10352) (US 2005/0080219) (U.S. Pat. No. 6,602,974, 2003).

Other processes for the preparation of end-capped oligomers, in contrast, use staged reactions in which controlled chain formation results from the individual addition steps (DE 10 248 876 and DE 10 353 094).

While Koller (US 2005/0080219) in his patent assumes that the polymer prepared bears at least one end group other than H, McCullough in his patent describes a synthesis variation in which a base (e.g. LDA) and a metal dihalide (e.g. ZnCl₂) have to be used in order that a polymer which bears a bromine atom as an end group can be prepared.

However, no application of the typical polymerization techniques for polythiophenes under particularly controlled conditions or to a process for preparing oligomers, i.e. specifically low molecular weight polymers, can be found in the literature.

Proceeding from the prior art mentioned, it was an object of the present invention to provide a simplified process which enables the preparation of polythiophenes or oligothiophenes with a defined mean chain length and a narrow molecular weight distribution. The controlled conditions needed for this purpose should be employed in optimized form in the process. In particular, a method should be found which enables the preparation of polymers and also of oligomers in the chain length range from 2 to 20 monomer units with a very narrow molecular weight distribution without restrictions in the conversion or the need for purifications of possible intermediates. At the same time, the processes should include advantages with regard to the space-time yield, handling, economy and ecology on the industrial scale.

The invention additionally provides a process for preparing oligo- or polythiophenes, comprising the process steps of:
(1) reacting at least one dissolved thiophene derivative having two leaving groups to give a polymerization-active monomer by
   a) mixing a solution of at least one dissolved thiophene derivative having two leaving groups with a solution of an organometallic compound or
   b) reacting a solution of at least one dissolved thiophene derivative having two leaving groups with elemental metal or
   c) reacting a solution of at least one dissolved thiophene derivative having two leaving groups with elemental metal and at least one alkyl halide.
(2) polymerizing the product solution from 1 by the metered addition of a solution of at least one catalyst
(3) polymerizing the product solution from 2 by the metered addition of at least one further solution prepared according to 1 with the aim of a chain extension based on the same thiophene derivative and/or at least one other thiophene derivative.

In step 1a), the solution of the at least one thiophene derivative having two leaving groups is reacted in equimolar amounts with the organometallic compound to give the polymerization-active monomer. In the case of reaction with elemental metal according to step 1b), the metal is present in excess and can be provided in various ways. In the reaction in step 1c), the metal is present in excess and at least one alkyl halide is added to the reaction solution.

Subsequently, catalyst is metered in step 2 to the polymerization-active monomer prepared in step 1 a) or b) or c), and then polymerized.

The invention additionally provides a process for preparing oligo- or polythiophenes, comprising the process steps of:
(1) reacting at least one dissolved thiophene derivative having two leaving groups to give a polymerization-active monomer by
   a) mixing a solution of at least one dissolved thiophene derivative having two leaving groups with a solution of an organometallic compound or
   b) reacting a solution of at least one dissolved thiophene derivative having two leaving groups with elemental metal
(2) polymerizing the product solution from 1 by the metered addition of a solution of at least one catalyst
(3) polymerizing the product solution from 2 by the metered addition of at least one further solution prepared according to 1 with the aim of a chain extension based on the same thiophene derivative and/or at least one other thiophene derivative.

Surprisingly and advantageously, it has now been found that an activation of the catalyst apparently achieved in step 2 and subsequent metered addition in step 3 of a reaction solution prepared in step 1 allows the amount of catalyst based on the desired chain length to be reduced significantly compared to that required in a polymerization with one-stage reaction (see Examples 1 and 4). The reaction of the catalyst in step 2 with the reaction solution prepared in step 1 appears to bring about an activation of the catalyst, such that—based on the mean molecular weights of the resulting end polymers or oligomers—a statistically approximately 100% catalyst efficiency is observed.

It is known from the prior art that, in the conventional preparation of polythiophenes, the catalyst is initially charged in different concentrations depending on the target molecular weight. Usually, amounts in the range of 1 to 0.5 mol % based on the monomer used are used. In general, in the polymerization of thiophenes having two active leaving groups, polymers with mean molecular weights (Mₙ) in the range of 20 000 to 40 000 g/mol are then obtained. Taking account of the amount used, this indicates, viewed in statistical terms, effective utilization of the catalyst in the range of 60 to 80% of the amount used.

Surprisingly and advantageously, in contrast, the process according to the invention succeeds in lowering the molecular weights achieved by means of the two-stage metering strategy of the polymerization-active organometallic thiophene derivatives formed as intermediates. This process thus reduces the mean molecular weight (Mₙ) of the polymer and brings about relatively narrow molecular weight distributions. Viewed in statistical terms, it can be suspected that virtually 100% of the catalytic sites are active.

Furthermore, the two-stage monomer metering enables a technically simple route to defined block copolymers or mixed copolymers.

In preferred embodiments of the process according to the invention, the reactants can be metered in differently. One possibility consists in preparing the polymerization-active monomers in the initial charge from the thiophene derivatives provided with two leaving groups, and then in metering in the dissolved catalyst, polymerizing in the batch and subsequently metering in further polymerization-active monomer.

A further conceivable variant is the mixing of catalyst and of the polymerization-active monomer mixture in the initial charge at low temperatures (approx. 15-25° C.), the subsequent polymerization by heating to polymerization temperature and subsequently metering in further polymerization-active monomer.

Also conceivable is the simultaneous metered addition of polymerization-active monomer mixture solution and catalyst solution, the rapid and complete mixing thereof and subsequent heating and hence polymerization and subsequent metered addition of further polymerization-active monomer.

In a preferred embodiment of the process according to the invention, the reaction of the catalyst according to step 2 is performed in the first metering step with 1-3 molar equivalents, preferably 1.5 to 2.5 molar equivalents, more preferably 1.8 to 2.2 molar equivalents, especially preferably 2 molar equivalents, of polymerization-active monomer according to step 1, and, in the second metering step according to step 3, the remaining amount, depending on the target molecular weight, of polymerization-active monomer is metered in.

In a preferred embodiment of the process according to the invention, the reaction is ended by adding a hydrolysing solvent to the polymerization solution, preferably an alkyl alcohol, more preferably ethanol or methanol, most preferably methanol. The precipitated product is filtered off, washed with the precipitant and then taken up in a solvent. Alternatively, purification can be effected in a Soxhlet apparatus, in which case preference is given to using nonpolar solvents, for example hexane, as the extractant.

In a particularly preferred embodiment, the process according to the invention is performed continuously. In this case, the metered addition and the preparation of the reactants can be effected differently.

Possible process steps to be conducted continuously are
reacting the solution with at least one thiophene derivative having two leaving groups with an organometallic compound according to step 1 a),
reacting the solution with at least one thiophene derivative having two leaving groups by providing a metal according to step 1 b),
reacting the solution with at least one thiophene derivative having two leaving groups by providing a metal and at least one alkyl halide according to step 1 c),
performing the polymerization by the reaction of polymerization-active monomers formed from thiophene derivatives having two leaving groups with a catalyst solution comprising at least one catalyst according to step 2 and/or
continuing the polymerization by at least one addition of further identical polymerization-active monomer or at least one different polymerization-active monomer for chain extension or preparation of defined block copolymers according to step 3.

A preferred embodiment of the process according to the invention is the continuous preparation of the polymerization-active monomers by mixing an organometallic reagent with the at least one thiophene derivative having two leaving groups according to step 1 a) or by reacting the thiophene derivative having two leaving groups with metal according to step 1 b) or 1 c) on a column as described in DE 10304006 B3 or by Reimschüssel, Journal of Organic Chemistry, 1960, 25, 2256-7, in a corresponding cartridge or in a tubular reactor provided with static mixers, as described in DD260276, DD260277 and DD260278 in a first module. As a result of the addition of at least one catalyst to the polymerization-active monomer and mixing at room temperature or at lower temperature (approx. 15-25° C.) in a second module, the continuous polymerization according to step 2 then proceeds in a third module at reaction temperature and under controlled conditions. In a fourth module, at least one further—identical or at least one different—monomer is metered in according to step 3. Preference is given to the delivery of two metered streams, in each case one for a polymerization-active monomer solution optionally to be prepared continuously and one for the catalyst solution. The reactant streams are mixed rapidly by a mixer. After mixing and polymerization in one module, in a further module, at least one further—identical or at least one different—monomer is correspondingly metered in and polymerized according to step 3.

In a preferred embodiment of the process according to the invention, the continuous reaction of the catalyst according to step 2 in the first metering stage is performed with 1-3 molar equivalents, preferably 1.5 to 2.5 molar equivalents, more preferably 1.8 to 2.2 molar equivalents, especially preferably 2 molar equivalents, of polymerization-active monomer according to step 1, and, in the second metering step according to step 3, the remaining amount, depending on the target molecular weight, of polymerization-active monomer is metered in.

The invention additionally provides a continuous process for preparing oligo- or polythiophenes, comprising the process steps of:
I. continuously converting at least one dissolved thiophene derivative having two leaving groups to a polymerization-active monomer by
   a) mixing a solution of at least one dissolved thiophene derivative having two leaving groups with a solution of an organometallic compound or
   b) flowing a solution of at least one dissolved thiophene derivative having two leaving groups through or over elemental metal initially charged in the apparatus,
   c) flowing a solution of at least one dissolved thiophene derivative having two leaving groups and at least one alkyl halide through or over elemental metal initially charged in the apparatus,
II. continuously polymerizing the product solution from 1 after metered addition of a solution of at least one catalyst.

Here too, in step Ia), the solution of the at least one thiophene derivative having two leaving groups is reacted in an equimolar amount with the organometallic compound to give the polymerization-active monomer. In the reaction with the elemental metal in step Ib) or Ic), the degree of thiophene-leaving group bonds converted to the corresponding polymerization-active bonds can be adjusted to an equimolar reaction (metal:thiophene derivative) through the residence time.

Catalyst is subsequently metered in step II to the polymerization-active monomer prepared according to step I a) or b) or c) and polymerized continuously.

The invention additionally provides a continuous process for preparing oligo- or polythiophenes, comprising the process steps of:
I. continuously converting at least one dissolved thiophene derivative having two leaving groups to a polymerization-active monomer by
   a) mixing a solution of at least one dissolved thiophene derivative having two leaving groups with a solution of an organometallic compound or
   b) flowing a solution of at least one dissolved thiophene derivative having two leaving groups through or over elemental metal initially charged in the apparatus,
II. continuously polymerizing the product solution from 1 after metered addition of a solution of at least one catalyst.

Here too, in step Ia), the solution of the at least one thiophene derivative having two leaving groups is reacted in an equimolar amount with the organometallic compound to give the polymerization-active monomer. In the reaction with the elemental metal in step Ib), the degree of thiophene-leaving group bonds converted to the corresponding polymerization-active bonds can be adjusted to an equimolar reaction (metal:thiophene derivative) through the residence time.

Catalyst is subsequently metered in in step II to the polymerization-active monomer prepared according to step I a) or b) and polymerized continuously.

The continuous reaction is particularly advantageous, since it enables higher space-time yields compared to the batchwise reaction of the prior art and leads to defined poly- and oligothiophenes having a narrow molecular weight distribution. Thus, in a surprisingly simple manner, inexpensive well-defined poly- and oligothiophenes are obtainable.

In a particularly preferred embodiment of the process according to the invention, after step II, in a step III, the
continuous polymerization of the product solution from II is continued by the metered addition of at least one further solution prepared according to I with the purpose of a chain extension based on the same thiophene derivative and/or at least one other thiophene derivative.

In a preferred embodiment of the invention, the at least one thiophene derivative having two leaving groups is one of the general formula

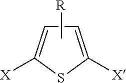

where
R, at position 3 or 4, is H or preferably an organic group, more preferably a non-reactive group or a protective group which contains preferably 5 or more carbon atoms, and
X and X′ are each independently a leaving group, preferably halogen, more preferably Cl, Br or I, and especially preferably Br.

Especially preferably, R is CN or a straight chain, branched or cyclic alkyl having one or more, preferably 5 or more, more preferably 1 to 20 atoms, which are unsubstituted or mono- or polysubstituted by CN, where one or more nonadjacent CH₂ groups may be replaced independently by —O—, —S—, —NH—, —NR′—, —SiR′R″—, —CO—, —COO—, —COO—, —COO—O—, —SO₂—, —S—CO—, —CO—S—, —CY¹═CY² or —C≡C—, and in such a way that oxygen and/or sulphur atoms are not bonded directly to one another, and are likewise optionally replaced by aryl or heteroaryl preferably containing 1 to 30 carbon atoms, where
R′ and R″ are each independently H or alkyl having 1 to 12 carbon atoms,
Y¹ and Y² are each independently H or CN.

Terminal CH₃ groups are understood to be CH₂ groups in the sense of CH₂—H.

Particularly preferred thiophene derivatives having two leaving groups are those in which
R is an organic group, preferably an alkyl group, which contains 5 or more carbon atoms,
R is an unbranched alkyl chain having 1 to 20, preferably 5 to 12, carbon atoms,
R is n-hexyl,
R is selected from C₁ to C₂₀ alkyl, C₁-C₂₀ alkenyl, C₁-C₂₀ alkynyl, C₁-C₂₀ alkoxy, C₁-C₂₀ thioalkyl, C₁-C₂₀ silyl, C₁-C₂₀ ester, C₁-C₂₀ amino, optionally substituted aryl or heteroaryl, especially C₁-C₂₀ alkyl, preferably unbranched chains,
R is selected from pentyl, hexyl, heptyl, octyl, nonyl, decyl, undecyl or dodecyl and/or
—CY¹═CY²— is preferably —CH═CH— or —CH═C(CN)—.

Aryl and heteroaryl preferably refer to a mono-, bi- or tricyclic aromatic or heteroaromatic group having up to 25 carbon atoms, likewise including fused ring systems which may optionally be substituted by one or more L groups where L may be an alkyl, alkoxy, alkylcarbonyl or alkoxycarbonyl group having 1 to 20 carbon atoms.

Particularly preferred aryl or heteroaryl groups are phenyl in which one or more CH groups have additionally been replaced by N, naphthalene, thiophene, thienothiophene, dithienothiophene, alkylfluorene and oxazole, each of which may be unsubstituted, monosubstituted or polysubstituted by L, where L is as defined above.

In a preferred embodiment of the process according to the invention, mixtures of two or more thiophene derivatives having two leaving groups may be used.

The at least one thiophene derivative having two leaving groups is, in accordance with the invention, present in solution.

The organometallic compounds which are used in the process according to the invention are preferably organometallic tin compounds, for example tributyltin chloride, or zinc compounds, for example activated zinc (Zn*), or borane compounds, for example B(OMe)₃ or B(OH)₃, or magnesium compounds, more preferably organometallic magnesium compounds, more preferably Grignard compounds of the formula R—Mg—X,
where R is alkyl and especially C₁, C₂, C₃, C₄, C₅, C₆, C₇, C₈, C₉, C₁₀, C₁₁, C₁₂-alkyl, more preferably C₂, C₃, C₄, C₅, C₆, C₇, C₈-alkyl, most preferably C₂-alkyl, and
   X is halogen, more preferably Cl, Br or I and especially preferably Br.

In a further preferred embodiment of the process according to the invention, instead of adding an organometallic compound, a metal or at least one alkyl halide with an elemental metal is provided, with whose aid the at least one thiophene derivative having two leaving groups can be converted to the polymerizable monomer mixture by providing a metal or at least one alkyl halide with an elemental metal. In this case, the metal can be added, for example, in the form of turnings, grains, particles or flakes, and can then be removed, for example, by filtration, or else provided to the reaction space in rigid form, for example by temporarily immersing wires, grilles, meshes or comparable materials into the reaction solution, or else in the form of a metal-equipped cartridge which can be flowed through in the interior or else as a fixed bed in a column in which the metal is present in turnings and is blanketed with solvent, in which case the thiophene derivatives having one or two leaving groups are converted as they flow through the cartridge or the column. Corresponding details for the continuous conduct of the reaction through columns and preferred apparatus can be taken from the patent DE 10 304 006 B3 or else the publication of Reimschüssel, Journal of Organic Chemistry, 1960, 25, 2256-7, whose embodiments or preferred embodiments for the preparation of the Grignard reagents also apply to the process according to the invention described here. Alternatively, the continuous conversion to the Grignard reagent can also be effected with high turbulence in tubular reactors equipped with static mixers, in which case the liquid column is subjected to pulses, as is known from the patents DD 260 276, DD 260 277 and DD 260 278. The embodiments for the preparation of the Grignard reagents preferred therein also apply to the process according to the invention described here.

The metals are preferably magnesium or zinc, more preferably magnesium.

The alkyl halide is one of the formula R-X

where
R is alkyl and especially C₁, C₂, C₃, C₄, C₅, C₆, C₇, C₈, C₉, C₁₀, C₁₁, C₁₂-alkyl, more preferably C₂, C₃, C₄, C₅, C₆, C₇, C₈-alkyl, most preferably C₂-alkyl, and
X is halogen, more preferably Cl, Br or I and especially preferably Br.

The alkyl halide with the elemental metal is particularly an ethyl halide and magnesium or zinc, more preferably ethyl bromide with magnesium.

The alkyl halide is preferably used in catalytic amounts, i.e. >0 to 0.5, preferably 0.001 to 0.1 and more preferably 0.01 to 0.05 equivalent in relation to the total amount of thiophene derivative used.

In the case of use of magnesium compounds, a solution of this compound is metered in, in which case the solvent need not correspond to that in the further process. In the case of use of elemental magnesium or elemental magnesium with at least one alkyl halide to prepare the intermediate organometallic thiophene compound, the reaction is effected with magnesium provided within the process. Unconverted magnesium is removed typically by suitable retaining devices, for example metal or glass frits.

The at least one catalyst used in the process according to the invention is one which is preferably used for regioselective polymerization, as cited in, for example, R. D. McCullough, Adv. Mater., 1998, 10(2), 93-116 and the references cited there, for example palladium or nickel catalysts, for example bis(triphenylphosphino)palladium dichloride (Pd(PPh₃)Cl₂), palladium(II) acetate (Pd(OAc)₂) or tetrakis(triphenylphosphine)palladium (Pd(PPh₃)₄) or tetrakis(triphenylphosphine)nickel (Ni(PPh₃)₄), nickel(II) acetylacetonate Ni(acac)₂, dichloro(2,2′-bipyridine)nickel, dibromobis(triphenylphosphine)nickel (Ni(PPh₃)₂Br₂), and nickel and palladium catalysts having ligands, for example tri-tert-butylphosphine, triadamantylphosphine, 1,3-bis(2,4,6-trimethylphenyl)imidazolidinium chloride, 1,3-bis(2,6-diisopropylphenyl)imidazolidinium chloride or 1,3-diadamantylimidazolidinium chloride, more preferably nickel catalysts and especially preferably bis(diphenylphosphino)propane nickel dichloride (Ni(dppp)Cl₂) or bis(diphenylphosphino)ethane nickel dichloride Ni(dppe)Cl₂. Likewise conceivable are those catalysts of palladium and nickel whose ligands consist of combinations of those mentioned above. In addition, in a preferred embodiment of the invention, the catalyst can be prepared and reacted with the polymerization-active monomer mixture “in situ”.

In a preferred embodiment of the process according to the invention, mixtures of two or more catalysts may be used.

According to the invention, the at least one catalyst is present in solution.

The thiophene derivatives having two leaving groups to be used in accordance with the invention and also the corresponding catalysts are typically commercially available or can be prepared by methods familiar to those skilled in the art.

Useful organic solvents for use in the process according to the invention include in principle all solvents or solvent mixtures which do not react under polymerization conditions with organometallic compounds, for example alkylmagnesium bromides or further organometallic compounds listed in this application. These are generally compounds which do not have any halogen atoms or any hydrogen atoms reactive toward organometallic compounds under polymerization conditions.

Suitable solvents are, for example, aliphatic hydrocarbons, for example alkanes, especially pentane, hexane, cyclohexane or heptane, unsubstituted or substituted aromatic hydrocarbons, for example benzene, toluene and xylenes, and compounds containing ether groups, for example diethyl ether, tert-butyl methyl ether, dibutyl ether, amyl ether, dioxane and tetrahydrofuran (THF), and also solvent mixtures of the aforementioned groups, for example a mixture of THF and toluene. In the process according to the invention, preference is given to using solvents which contain ether groups. Very particular preference is given to tetrahydrofuran. However, it is also possible to use, as solvents, mixtures of two or more of these solvents. For example, it is possible to use mixtures of tetrahydrofuran, the solvent used with preference, and alkanes, e.g. hexane (for example present in commercially available solutions of starting materials such as organometallic compounds). What is important in the context of the invention is that the solvent, the solvents or mixtures thereof are selected such that, before addition of the catalyst, the thiophene derivatives used or the polymerization-active monomers are present in dissolved form. For the workup, halogenated aliphatic hydrocarbons such as methylene chloride and chloroform are also suitable.

In a particularly preferred embodiment of the process according to the invention, 3-alkylthiophene is polymerized by the regioselective reaction of a solution of dihalogenated 3-alkylthiophene using a Grignard reagent or elemental magnesium to give a corresponding polymerization-active organomagnesium bromide compound and the subsequent polymerization thereof in the presence of a nickel catalyst. Especially preferred is the equimolar reaction of 2,5-dibromo-3-hexylthiophenene in THF solution with ethylmagnesium bromide and the subsequent polymerization thereof in the presence of Ni(dppp)Cl₂.

The amount of the catalyst added depends on the target molecular weight and is typically in the range of 0.1-20 mol %, preferably in the range of 10-20 mol %, more preferably in the range of 10-15 mol %, based in each case on the molar amount of the thiophene derivative used.

It has been found to be useful to use Ni(dppp)Cl₂ catalyst concentrations of 0.1 to 20 mol % based on the amount of monomers used, according to the target molecular weight.

The process according to the invention serves to prepare poly- and oligothiophenes. Preference is given to the preparation of degrees of polymerization, i.e. number of repeat units n in the chain, of 2 to 5000, especially of 10 to 5000 or of 110 to 5000, more preferably of 50 to 1000, most preferably of 100 to 1000. Depending on the molecular weight of the monomeric thiophene derivative, the molecular weight is 5000 to 300 000, preferably 10 000 to 100 000, more preferably 15 000 to 100 000, especially preferably 20 000 to 60 000. In the case of oligothiophenes, preference is given to the preparation of chain lengths where n is 2 to 20 monomer units, preferably 2 to 10, more preferably 4 to 8, and of a narrow molecular weight distribution with a polydispersity index PDI of 1 to 3, preferably PDI<2, more preferably PDI=1.1 to 1.7. It is notable in that the mean molecular weight or the mean chain length, as a result of the two-stage metering strategy with an activation of the catalyst in the first metering stage and the continued polymerization within the second metering stage, can be defined precisely by the amount of the catalyst according to [thiophene derivative having two leaving groups]/[catalyst]. Furthermore, it is notable in that the continuous conduct of the reaction leads to higher space-time yields than comparable prior art batchwise polymerizations. The fact that complicated purifications of any intermediates are not necessary increases the economic attractiveness of the process considerably and also facilitates industrial performance.

The polymers and oligomers prepared by the process additionally feature the presence of one or two leaving groups at the chain end, which, in the further course, can serve as substitution sites for functionalizations or end-capping reactions.

A preferred embodiment of the process according to the invention is the continuous preparation of the polymerization-active monomer mixture by mixing an organometallic reagent with the thiophene derivatives having two leaving groups or by reacting the thiophene derivatives having two leaving groups with metal or by reacting the thiophene derivatives having two leaving groups and at least one alkyl halide with metal on a column as described in DE 10304006 B3, and in an apparatus as described by Reimschüssel, Journal of Organic Chemistry, 1960, 25, 2256-7, in a corresponding cartridge or in a tubular reactor provided with static mixers as described in DD260276, DD260277 and DD260278 in a first module. As a result of the addition of the catalyst to the polymerization-active monomer mixture and mixing at room temperature or at lower temperature (approx. 15-25° C.) in a second modules, the continuous polymerization is subsequently effected in a third modules at reaction temperature and under controlled conditions. In a fourth module, at least one further—identical or at least one different—monomer is metered in. Particular preference is given to primary activation of the catalyst by the preceding reaction, optionally to be performed continuously, with 1-3 molar equivalents, preferably 1.5 to 2.5 molar equivalents, more preferably 1.8 to 2.2 molar equivalents, especially preferably 2 molar equivalents, of polymerization-active monomers formed from thiophene derivative having two leaving groups. Preference is given to the delivery of two metering streams, in each case one for the polymerization-active monomer solution and one for the optionally activated catalyst solution. The reactant streams are mixed rapidly by a mixer.

Temperatures suitable for the performance in the process according to the invention are generally in the range of +20 to +200° C., preferably in the range of +80 to +160° C. and especially +100 to +140° C. Owing to the low boiling temperatures of the solvents used, the reaction is effected at elevated pressures, preferably at 1-30 bar, especially at 2-8 bar and more preferably in the range of 4-7 bar.

The metering rates depend primarily on the residence times desired and conversions to be achieved.

Typical residence times are in the range of 5 min to 120 min. The residence time is preferably between 10 and 40 min, preferably in the range of 20-40 min.

It has been found in this context that the use of microreaction technology (μ-reaction technology) using microreactors is particularly advantageous. The term “microreactor” used represents microstructured, preferably continuous reactors, which are known under the name microreactor, minireactor, micro-heat exchanger, minimixer or micromixer. Examples are microreactors, micro-heat exchangers, T and Y mixers and also micromixers from a wide variety of different companies (e.g. Ehrfeld Mikrotechnik BTS GmbH, Institut für Mikrotechnik Mainz GmbH, Siemens AG, CPC-Cellulare Process Chemistry Systems GmbH), and others as generally known to those skilled in the art, and a “microreactor” in the context of the present invention typically has characteristic/determining internal dimensions of up to 1 mm and may contain static mixing internals. A preferred microreactor for the process according to the invention has internal dimensions of 100 μm to 1 mm.

As a result of the use of a micromixer (μ-mixer), the reaction solutions are mixed with one another very rapidly, as a result of which a broadening of the molecular weight distribution owing to possible radial concentration gradients is prevented. Furthermore, microreaction technology (μ-reaction technology) in a microreactor (μ-reactor) enables a usually significantly narrower residence time distribution than in conventional continuous apparatus, which likewise prevents broadening of the molecular weight distribution.

In a particularly preferred embodiment, the process according to the invention is performed continuously using μ-reaction apparatus.

After the reaction of the first process step, a catalyst solution is metered in by means of a μ-mixer. In a suitable, temperature-controlled delay zone, the reaction is effected. Thereafter, there is another metered addition of an organometallic thiophene derivative prepared by step 1 with the aid of a μ-mixer and the conversion to the desired product in a suitable temperature-controlled delay zone.

In all cases, the polymerization is started by the increase in the temperature. In this context too, one possibility in particular is to use a micro-heat exchanger (μ-heat exchanger), which enables rapid and controlled temperature increase of the reaction solution, which is advantageous for a narrow molecular weight distribution.

For the increase in the conversion, the reaction solution is conveyed through a delay zone and converted under pressure and at higher temperatures than described to date in the literature.

The process according to the invention features in particular the controlled establishment of a desired mean chain length, and also the preparation of products having a narrow molecular weight distribution. In addition, the continuous conduction of the polymerization enables a significant increase in the space-time yield.

The inventive use of a two-stage metering strategy for the polymerization of the organometallic thiophene derivative allows, with regard to the desired mean chain length and molecular weights, the amounts of catalyst needed to be reduced very significantly and the mean molecular weights for a given amount of catalyst to be lowered significantly.

The invention likewise provides the oligothiophenes obtainable by the process according to the invention.

The invention will be illustrated in detail hereinafter with reference to examples, but without restricting it to them.

### EXAMPLES

In all examples, the syntheses are performed under protective gas.

### Example 1

### Batchwise polymerization of 2,5-dibromo-3-hexylthiophene

2,5-Dibromo-3-hexylthiophene (4 mmol) was initially charged in 20 ml of THF under protective gas in a 50 ml three-neck flask equipped with a reflux condenser, nitrogen connection and thermometer, and heated under reflux. After the addition of 1 M solution of methylmagnesium bromide in hexane, (4 ml, 4 mmol), the reaction solution was heated under reflux for one hour. Subsequently, 0.4 mmol of Ni(dppp)Cl₂ as a catalyst was added to the reaction solution which was heated under reflux for a further 2 hours. To end the reaction, 40 ml of methanol were added to the solution. The product precipitated in methanol was filtered off, washed with methanol and then taken up in THF. 676 mg of product (yield approx. 80%) were obtained. GPC analysis: M_{w}=6990 g/mol, Mₙ=3040 g/mol, PDI=2.3 (measured against polystyrene standards, THF as the eluent (0.6 ml/min)).

### Example 2

### Continuous polymerization of 2,5-dibromo-3-hexylthiophene

2,5-Dibromo-3-hexylthiophene (4 mmol) was initially charged in 20 ml of THF under protective gas conditions in a 50 ml three-neck flask equipped with a reflux condenser, nitrogen connection and thermometer, and heated under reflux. After the addition of 1 M solution of methylmagnesium bromide in hexane, (4 ml, 4 mmol), the reaction solution was heated under reflux for one hour. The solution was then cooled to approx. 15° C. Subsequently, 0.4 mmol of Ni(dppp)Cl₂ as a catalyst was added to the reaction solution. The reaction mixture was subsequently pumped through a reaction capillary continuously at 100° C. and under 5 bar. The residence time was 40 min. After about 4 residence times, a sample was taken. The product prepared was precipitated in methanol, removed, washed with methanol and taken up in THF. The conversion was 75-80%. GPC analysis: M_{w}=7760 g/mol, Mₙ=2700 g/mol, PDI=2.8.

### Example 3

### Continuous polymerization of 2,5-dibromo-3-hexylthiophene with catalyst activation

Reaction of the 2,5-dibromo-3-hexylthiophene with ethylmagnesium bromide

Metering stream A: 0.3 M 2,5-dibromo-3-hexylthiophene in THF, 9.2 ml/h

Metering stream B: 1 M ethylmagnesium bromide in diethyl ether, 2.8 ml/h

Mixer: μ-structured cascade mixer

Delay reactor: capillary reactor, volume 8 ml, internal diameter Dᵢₙₜₑᵣₙₐₗ=1 mm

Delay time=40 min

Temperature=80° C.

### Catalyst Activation

Metering stream C: 0.23 M 2-bromo-5-bromomagnesium-3-hexylthiophene, 4.8 ml/h

Metering stream D: 1 M Nickel(dppp)Cl₂ in THF, 1.1 ml/h

Mixer: μ-structured cascade mixer

Delay reactor: capillary reactor, volume 4 ml, =1 mm

Delay time=40 min

Temperature=80° C.

### Polymerisation

Metering stream E: metering stream from catalyst activation, 5.9 ml/h

Metering stream F: 0.23 M 2-bromo-5-bromomagnesium-3-hexylthiophene, 6.2 ml/h

Mixer: μ-structured cascade mixer

Delay reactor: capillary reactor, volume 8 ml, Dᵢₙₜₑᵣₙₐₗ=1 mm

Delay time=40 min

Temperature=100° C.

Conversion (HPLC)=78%, GPC analysis: M_{w}=1180 g/mol, Mₙ=850 g/mol, PDI=1.4

### Example 4

### Batchwise polymerization of 2,5-dibromo-3-hexylthiophene with catalyst activation

Flask A: 2,5-dibromo-3-hexylthiophene (4 mmol) is initially charged in 10 ml of THF under protective gas conditions in a 50 ml three-necked flask equipped with a reflux condenser, nitrogen connection and thermometer, and heated under reflux. After the addition of 1M solution of methylmagnesium bromide in hexane (4 ml, 4 mmol), the reaction solution is heated under reflux for one hour.

Flask B: 2,5-dibromo-3-hexylthiophene (1 mmol) is initially charged in 10 ml of THF under protective gas conditions in a 50 ml three-necked flask equipped with a reflux condenser, nitrogen connection and thermometer, and heated under reflux. After the addition of 1M solution of methylmagnesium bromide in hexane (1 ml, 1 mmol), the reaction solution is heated under reflux for one hour. Subsequently, 0.5 mmol of Ni(dppp)Cl₂ is added to the reaction solution as a catalyst and the mixture is heated under reflux for 1 hour.

Subsequently, the contents of flask A are added to flask B and the reaction is continued under reflux for 2 hours. To end the reaction, 40 ml of methanol are added to the solution. The product precipitated in methanol is filtered off, washed with methanol and then taken up in THF. 620 mg of product (yield approx. 73%) are obtained. GPC analysis: M_{w}=2320 g/mol, Mₙ=1690 g/mol, PDI=1.37.

1. Process for preparing oligo- or polythiophenes, comprising the process steps of:
1. reacting at least one dissolved thiophene derivative having two leaving groups to give a polymerization-active monomer by
a) mixing a solution of at least one dissolved thiophene derivative having two leaving groups with a solution of an organometallic compound or
b) reacting a solution of at least one dissolved thiophene derivative having two leaving groups with elemental metal
2. polymerizing the product solution from 1 by the metered addition of a solution of at least one catalyst
3. polymerizing the product solution from 2 by the metered addition of at least one further solution prepared according to 1 to achieve a chain extension based on the same thiophene derivative and/or at least one other thiophene derivative.

2. Process according to claim 1, wherein at least one of the process steps of
reacting the solution with at least one thiophene derivative having two leaving groups with an organometallic compound according to step 1 a),
reacting the solution with at least one thiophene derivative having two leaving groups by providing a metal according to step 1 b),
performing the polymerization by the reaction of polymerization-active monomers formed from thiophene derivatives having two leaving groups with a catalyst solution comprising at least one catalyst according to step 2 and/or
continuing the polymerization by at least one addition of further identical polymerization-active monomer or at least one different polymerization-active monomer according to step 3
is conducted continuously.

3. Process according to claim 1, wherein that the at least one catalyst according to step 2 is activated in the first metered addition step with 1 to 3 molar equivalents of polymerization-active monomer formed from thiophene derivative having two leaving groups.

4. Continuous process for preparing oligo- or polythiophenes, comprising the process steps of:
I. continuously converting at least one dissolved thiophene derivative having two leaving groups to a polymerization-active monomer by
a) mixing a solution of at least one dissolved thiophene derivative having two leaving groups with a solution of an organometallic compound or
b) flowing a solution of at least one dissolved thiophene derivative having two leaving groups through or over elemental metal in an apparatus initially charged with the elemental metal,
II. continuously polymerizing the product solution from I after metered addition of a solution of at least one catalyst.

5. Process according to claim 4, wherein, after step II, in a step III, the continuous polymerization of the product solution from II is continued by the metered addition of at least one further solution prepared according to I with the purpose of a chain extension based on the same thiophene derivative and/or at least one other thiophene derivative.

6. Process according to claim 4, wherein the at least one catalyst is activated with 1 to 3 molar equivalents of polymerization-active monomer formed from thiophene derivative with two leaving groups.

7. Process according to claim 4, wherein the apparatus utilized for the continuous process are micromixers, microreactors and micro-heat exchangers.

8. Process according to claim 1, wherein a narrow molecular weight distribution of the poly- or oligothiophene having a polydispersity index of 1 to 3 is achieved.

9. Process according to claim 1, wherein at least one Pd or Ni catalyst is used.

10. Process according to claim 1, wherein the at least one thiophene derivative having two leaving groups is one of the formula: 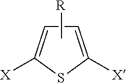
where
R. at the 3 or 4 position is H or an organic group, and
X and X′ are each independently a leaving group.

11. Process according to claim 1, wherein the organometallic compounds include Grignard compounds of the formula R—Mg—X
where R is C₁, C₂, C₃, C₄, C₅, C₆, C₇, C₈, C_{g}, C₁₀, C₁₁, or C₁₂-alkyl, and
X is halogen, and
the metal to be provided is magnesium or zinc.

12. Process according to claim 1, wherein the solvent used comprises at least one ether component.

13. Process according to claim 1, wherein the process is performed within a temperature range of +20 to +200° C. and a pressure of 1-30 bar.

14. The process of claim 10, wherein R is an organic group and said organic group is a non-reactive group or a protecting group.

15. The process of claim 10, wherein X and X′ are halogen.

16. The process of claim 15, wherein said halogen is Cl, Br or I.

17. The process of claim 16, wherein said halogen is Br.
